(19) United States
(12) Patent Application Publication
(10) Pub. No.: US 2016/0210641 A1
(43) Pub. Date: Jul. 21, 2016

(54) DETERMINING MEDIA SPEND APPORTIONMENT PERFORMANCE

(71) Applicants: Anto Chittilappilly, Waltham, MA (US); Payman Sadegh, Alpharetta, GA (US)

(72) Inventors: Anto Chittilappilly, Waltham, MA (US); Payman Sadegh, Alpharetta, GA (US)

(21) Appl. No.: 14/978,403

(22) Filed: Dec. 22, 2015

Related U.S. Application Data
(60) Provisional application No. 62/099,077, filed on Dec. 31, 2014.

(51) Int. Cl. G06Q 30/02

(52) U.S. Cl. CPC G06Q 30/0202; G06Q 30/0201

(57) ABSTRACT

A system, method, and computer program product for determining media spend apportionment performance. A set of historical stimulus and response data is used to form a stimulus response predictive model for generating correlations and for generating historical performance results. The historical stimulus and historical performance results are used to determine a set of recommended stimuli that are applied to the stimulus response predictive model to simulate or predict responses that in turn are used to further predict the performance of sets of recommended stimuli. New spending on the recommended stimuli produces new responses. The new responses to a set of newly-deployed stimuli (such as changed spending in accordance with the recommended stimuli) can be measured so as to generate performance results pertaining to the newly-deployed stimuli. Individual stimuli and/or combinations of historical stimuli, recommended stimuli, and/or the deployed stimuli are analyzed against media spend apportionment plans. Performance results are compared.

### RELATED APPLICATIONS

The present application claims the benefit of priority to U.S. Patent Application Ser. No. 62/099,077, entitled “DETERMINING MEDIA SPEND APPORTIONMENT PERFORMANCE” (Attorney Docket No. VISQ.P0017P), filed Dec. 31, 2014 which is hereby incorporated by reference in its entirety.

### FIELD OF THE INVENTION

The disclosure relates to the field of managing an Internet advertising campaign and more particularly to techniques for determining media spend apportionment performance.

### BACKGROUND

Current marketing and advertising campaigns involve many channels (e.g., online display, online search, TV, radio, print media, etc.) and the combination of channels are selected by a marketing manager to achieve one or more objectives (e.g., brand recognition, lead generation, prospect conversion, etc.). Increasing the spending on stimuli in a given channel (e.g., online display, TV, radio, etc.) and/or associated with a given touchpoint (e.g., online display ads, TV ads, radio spots, etc.) can sometimes be increased in expectation of expanding the marketplace response (e.g., increased product sales, increased pull-through, etc.). In some cases, spending in one channel can produce responses in other channels (e.g., more TV ads might increase the likelihood that a coupon in a newspaper ad will be clipped). A marketing manager might include many such channels in a media portfolio, and might apportion a media spend budget across the channels in a media portfolio in an effort to maximize the marketplace response. The effects of increasing or decreasing spend in one channel may impact other channels, and the impacted channels may impact other channels, and so on. While the effects of increasing or decreasing spend in one or another channel might be measurable, the interrelationships between channels is complex, and a marketing manager might not have the facility to accurately calculate the economic effect of the manager's own spending apportionment choices. Still further, when a marketing manager uses sophisticated tools that facilitate apportionment recommendations and decisions, the measurements become still more complex, and the marketing manager would need sophisticated tools to aid in determining the economic effect of the apportionment scenarios considered and/or deployed. As an example, a given marketing campaign comprising a unique combination of multiple media channels and stimuli has no comparable performance benchmark (e.g., analogous to a stock index) to reference, presenting challenges in discerning acceptable and/or target performance levels.

In legacy environments, marketing managers have relied on subjective or “soft” data and/or anecdotal data when trying to determine how media spend reapportionments improved the economic performance of the reapportioned media portfolio. Advances in media portfolio modeling sometimes can aid the marketing manager to use mathematical techniques to quantitatively simulate a “recommended” apportionment of a given media spend budget across the channels in a given media portfolio and predict the marketplace response. In some cases, for example, the recommended apportionment might serve as a performance benchmark proxy. The marketing manager can then deploy the recommended media spend apportionment, or some other updated media spend apportionment (e.g., a combination of a historical apportionment and the recommended apportionment), in efforts to improve the performance (e.g., return on advertising spend or ROAS, return on investment or ROI, etc.) of the overall media portfolio.

As media spend adjustments are made and time elapses during the progression of the media campaign, the marketing manager would want to evaluate the performance of such media spend adjustments. However, legacy approaches for determining the performance of media spend apportionment performance fall short in at least the following aspects:
Performance feedback. For example, legacy approaches receive measured response data in batch form collected over certain time periods (e.g., 30 days), resulting in delayed performance measurements of a deployed media spend plan.
Performance benchmarks. For example, maximum response curves, maximum ROI curves, and/or other performance limits are not well understood in legacy approaches, limiting the ability to establish performance targets and/or benchmarks.
True channel attribution. For example, channel saturation and/or cross-channel effects are not addressed in channel attribution models, leading to inaccurate performance predictions and performance measurements.
Performance driver discernment. For example, legacy approaches fail to include all drivers and variables (e.g., stimuli, responses, measurements, time windows, etc.), thus limiting the ability to discern true performance drivers and to distinguish from measurement errors and/or prediction errors and/or other variables.

Techniques are therefore needed to address the problem of measuring and comparing the performance of various simulated and deployed media spend apportionment scenarios. None of the aforementioned legacy approaches achieve the capabilities of the herein-disclosed techniques for determining media spend apportionment performance, and for reporting performance (e.g., return on advertising spend or ROAS, return on investment or ROI, etc.) in a manner that can provide insight that the marketing manager can act upon. Therefore, there is a need for improvements.

### SUMMARY

The present disclosure provides an improved system, method, and computer program product suited to address the aforementioned issues with legacy approaches. More specifically, the present disclosure provides a detailed description of techniques used in systems, methods, and computer program products for determining media spend apportionment performance.

The herein disclosed techniques enable receiving a set of historical stimulus and response data to form a stimulus response predictive model for generating historical performance results. The historical data and performance results are used to determine a set of recommended stimuli that are applied to the stimulus response predictive model to predict a set of predicted responses used to further predict the performance of the recommended stimuli. Responses to a set of deployed stimuli derived from the recommended stimuli can be measured over a network to generate performance results for the deployed stimuli. In one or more embodiments, the historical stimuli, the recommended stimuli, or the deployed stimuli are associated with a respective media spend apportionment plan. In one or more embodiments, the performance results are compared to identify a set of differences among the various sets of stimuli (e.g., ROI based on historical media spend versus ROI based on recommended media spend). In one or more embodiments, a maximum response curve and a maximum performance curve are generated in order to facilitate comparisons.

Further details of aspects, objectives, and advantages of the disclosure are described below and in the detailed description, drawings, and claims. Both the foregoing general description of the background and the following detailed description are exemplary and explanatory, and are not intended to be limiting as to the scope of the claims.

### BRIEF DESCRIPTION OF THE DRAWINGS

FIG. 1A depicts techniques for determining media spend apportionment performance, according to some embodiments.

FIG. 1B depicts an environment in which embodiments of the present disclosure can operate.

FIG. 2A presents a portfolio schematic showing multiple channels as used in systems for determining media spend apportionment performance.

FIG. 2B is a portfolio schematic depicting stimulus and response vectors as used in systems for determining media spend apportionment performance.

FIG. 3A depicts a learning model development flow as used in systems for determining media spend apportionment performance, according to some embodiments.

FIG. 3B depicts a simulated model development flow as used in systems for determining media spend apportionment performance, according to some embodiments.

FIG. 3C depicts a recommended stimuli development flow as used in systems for determining media spend apportionment performance, according to some embodiments.

FIG. 4A depicts a chart illustrating example media spend apportionment plans.

FIG. 4B shows apportionment plan performance results determined for various media spend apportionment plans, according to some embodiments.

FIG. 5 depicts a subsystem for determining media spend apportionment performance, according to some embodiments.

FIG. 6 depicts a flowchart for determining media spend apportionment performance, according to some embodiments.

FIG. 7A is a block diagram of a system for determining media spend apportionment performance, according to some embodiments.

FIG. 7B is a block diagram of a system for determining media spend apportionment performance, according to some embodiments.

FIG. 8A and FIG. 8B depict block diagrams of computer system components suitable for implementing embodiments of the present disclosure.

### DETAILED DESCRIPTION

### Overview

Current marketing and advertising campaigns involve many channels (e.g., online display, online search, TV, radio, print media, etc.) and the combination of channels are selected by a marketing manager to achieve one or more objectives (e.g., brand recognition, lead generation, prospect conversion, etc.). Increasing the spending on stimuli in a given channel (e.g., online display ads, TV ads, radio spots, etc.) can sometimes be increased in expectation of expanding the marketplace response (e.g., increased product sales, etc.). In some cases, spending in one channel can produce responses in other channels (e.g., more TV ads might increase the likelihood that a coupon in a newspaper ad will be clipped). A marketing manager might include many such channels in a media portfolio, and might apportion a media spend budget across the channels in a media portfolio in efforts to maximize the marketplace response. The effects of increasing or decreasing spend in one channel may impact other channels, and the impacted channels may impact other channels, and so on. While the effects of increasing or decreasing spend in one or another channel are measurable, the interrelationships between channels is complex, and a marketing manager might not have the facility to accurately calculate the economic effect of the marketing manager's own spending apportionment choices. Still further, when a marketing manager uses sophisticated tools to aid in making apportionment recommendations and decisions, the measurements become still more complex, and the marketing manager would need sophisticated tools to aid in determining the economic effect of the apportionment decisions taken.

Use of Internet data collection and manipulation techniques allow a marketing manager to quantitatively simulate a “recommended” apportionment of a given media spend budget across the channels in a given media portfolio and predict the marketplace response. In some cases, for example, the recommended apportionment might serve as a performance benchmark proxy. The marketing manager can then deploy the recommended media spend apportionment, or some other updated media spend apportionment (e.g., a combination of a historical apportionment and the recommended apportionment), in an effort to improve the performance (e.g., ROAS, ROI, etc.) of the overall media portfolio.

The techniques disclosed herein address the deficiencies of legacy approaches used in calculating performance measurements. Various individual techniques as well as combinations of the advanced techniques herein-disclosed are used for comparing performance metrics across various media campaign spend scenarios. For example, stimulus and response data might be collected for an actual historical apportionment, a simulated recommended apportionment, and an actual deployed apportionment to determine the performance improvement provided by the deployed apportionment over the historical apportionment and/or recommended apportionment. By calculating and comparing the performance of all three apportionments, the performance improvement can be distinguished from other variables that might be present (e.g., response prediction errors, recommended stimuli and deployed stimuli differences, etc.). In some cases, the measured responses to the deployed stimuli apportionment can be collected continually from the Internet so as to detect such performance differences nearly synchronously with the audience interactions with the deployed stimuli. The herein disclosed techniques further use a learning model and simulated model (e.g., stimulus response predictive model) for determining true channel attribution and establishing performance limits.

### DEFINITIONS

Some of the terms used in this description are defined below for easy reference. The presented terms and their respective definitions are not rigidly restricted to these definitions—a term may be further defined by the term's use within this disclosure.
The term “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.
As used in this application and the appended claims, the term “or” is intended to mean an inclusive “or” rather than an exclusive “or”. That is, unless specified otherwise, or is clear from the context, “X employs A or B” is intended to mean any of the natural inclusive permutations. That is, if X employs A, X employs B, or X employs both A and B, then “X employs A or B” is satisfied under any of the foregoing instances.
The articles “a” and “an” as used in this application and the appended claims should generally be construed to mean “one or more” unless specified otherwise or is clear from the context to be directed to a singular form.

Reference is now made in detail to certain embodiments. The disclosed embodiments are not intended to be limiting of the claims.

### Descriptions of Exemplary Embodiments

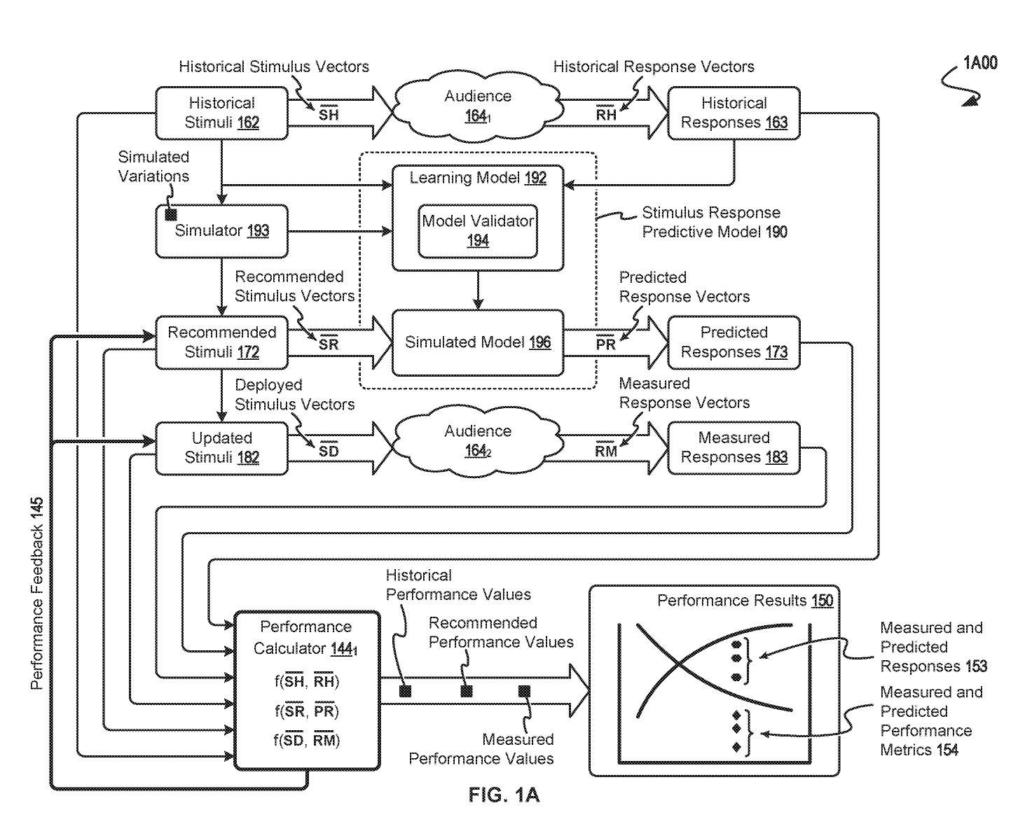

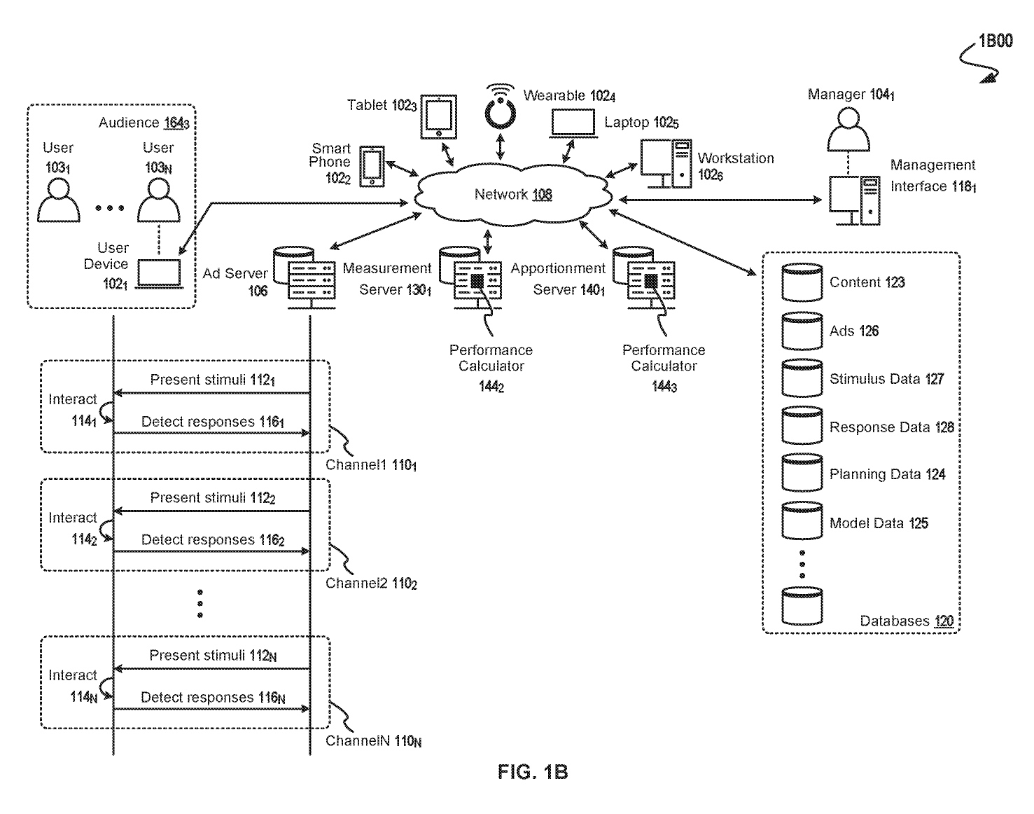

FIG. 1A depicts techniques 1A00 for determining media spend apportionment performance, according to some embodiments. As an option, one or more instances of techniques 1A00 or any aspect thereof may be implemented in the context of the architecture and functionality of the embodiments described herein. Also, techniques 1A00 or any aspect thereof may be implemented in any desired environment.

One approach to optimizing media spend apportionment uses marketing stimuli attributions and predictions determined from historical data. Analysis of the historical data can serve to infer relationships between marketing stimuli and responses. In some cases, the historical data comes from “online” outlets, and is comprised of individual user-level data, where a direct cause-effect relationship between stimuli and responses can be verified. However, “offline” marketing channels such as television advertising, are of a nature such that indirect measurements are used when developing models used in media spend optimization. For example, stimuli are described as an aggregate (e.g., TV spots on Prime Time News, Monday, Wednesday and Friday) that merely provide a description of an event or events as a time-series of marketing stimuli (e.g., weekly television advertising spends). Offline responses are also measured and/or presented in aggregate (e.g., weekly unit sales reports provided by the telephone sales center). However correlations, and in some cases causality and inferences, between stimuli and responses can be determined via statistical methods.

Further details regarding techniques related to optimizing media spend are disclosed in U.S. patent application Ser. No. 14/145,521, entitled “MARKETING PORTFOLIO OPTIMIZATION” (Attorney Docket No. VISQ.P0007) filed on Dec. 31, 2013, the contents of which is incorporated by reference in its entirety in this application.

Further details regarding techniques related to optimizing media spend are disclosed in U.S. patent application Ser. No. 14/584,588, entitled “REAL-TIME MARKETING PORTFOLIO OPTIMIZATION AND REAPPORTIONING” (Attorney Docket No. VISQ.P0009) filed on Dec. 29, 2014, the contents of which are incorporated by reference in its entirety in this application.

Further details of a predictive model are described in U.S. application Ser. No. 14/145,625 (Attorney Docket No. VISQ.P0004) entitled, “MEDIA SPEND OPTIMIZATION USING CROSS-CHANNEL PREDICTIVE MODEL”, filed Dec. 31, 2013, the contents of which are incorporated by reference in its entirety in this application and in U.S. application Ser. No. 13/492,493 (Attorney Docket No. VISQ.P0003) entitled, “A METHOD AND SYSTEM FOR DETERMINING TOUCHPOINT ATTRIBUTION”, filed Jun. 8, 2012, the contents of which are incorporated by reference in its entirety in this application.

As shown in FIG. 1A, a set of historical stimuli 162 (e.g., ad placements) have been deployed to an audience 164₁ in the marketplace and undergo a plurality of marketplace dynamics resulting in a set of historical responses 163. As shown, the historical stimuli 162 can be represented by a set of historical stimulus vectors (e.g., S̅H̅), and the historical responses 163 can be represented by a set of historical response vectors (e.g., R̅H̅). Generally, at least one type of response measurement in the historical responses 163 is attempted for each stimulus in the historical stimuli 162. For example, a “TV Prime Time News” placement might be measured by a “Nielsen Household Share” metric. As shown, a learning model 192 can be formed using the historical stimuli 162 and historical responses 163. The learning model 192 serves to predict a particular channel response from a particular channel stimulus. For example, if a radio spot from last Saturday and Sunday resulted in some number of calls to the broadcasted 1-800 number, then the learning model 192 can predict that additional radio spots next Saturday and Sunday might result in the same number of calls to the broadcasted 1-800 number. One technique to train the learning model 192 uses a simulator 193 and a model validator 194, as shown. The simulator 193 can provide various subsets of historical stimuli 162 to the learning model 192, and the responses predicted by the learning model 192 are compared by the model validator 194 to the expected responses from the historical responses 163 so as to adjust the learning model 192 such that a true attribution of response credit to a given stimulus and/or set of stimuli can be established.

Further, a simulator wrapper can contain a simulated model 196 and can serve to determine a set of recommended stimuli 172 (e.g., recommended touchpoint encounters) and associated set of corresponding predicted responses 173 even when direct measurements are not available. In some cases, for example, the predicted responses 173 might serve as a performance benchmark proxy. As shown, the recommended stimuli 172 can be represented by a set of recommended stimulus vectors (e.g., S̅R̅), and the predicted responses 173 can be represented by a set of predicted response vectors (e.g., P̅R̅). The simulated model 196 can be formed using any machine learning techniques and/or operations shown in FIG. 1A. Specifically, the embodiment of FIG. 1A shows a technique where simulated variations (e.g., mixes) of the historical stimuli 162 are delivered by the simulator 193 to the learning model 192 so as to capture predictions of the responses to a particular stimuli variation (e.g., media spend scenario). A full range of simulated variations of the stimulus and associated predicted response variations form, in part, the simulated model 196. Such techniques can also serve to establish response and performance limits. In some embodiments, the learning model 192, the model validator 194, and a simulated model 196 can comprise a stimulus response predictive model 190.

A marketing manager and/or third-party marketing consultant might use the simulator 193 and the simulated model 196 to establish the recommended stimuli 172 that best addresses a set of marketing objectives. For example, the predicted responses 173 determined by the simulated model 196 might be expected to produce the maximum performance (e.g., ROAS, ROI, etc.) for a given marketing budget. In such cases, the predicted responses 173 might serve as a performance benchmark proxy. The recommended stimuli 172 can be used to establish a set of updated stimuli 182 to be deployed to the audience 1642 that can interact with the updated stimuli 182 to produce a set of measured responses 183. As shown, the deployed instances of the updated stimuli 182 can be represented by a set of deployed stimulus vectors (e.g., S̅D̅), and the measured responses 183 can be represented by a set of measured response vectors (e.g., R̅M̅). In some cases, the updated stimuli 182 can be the same as the recommended stimuli 172. In other cases, the updated stimuli 182 can vary from the recommended stimuli 172. Further, the recommended stimuli 172 and/or the updated stimuli 182 can be determined automatically (e.g., without input by the marketing manager and/or another user) by systems implementing the herein disclosed techniques.

As previously discussed, the marketing manager might want to measure the performance of the updated stimuli 182 as compared to the recommended stimuli 172 and the historical stimuli 162. In one or more embodiments, the herein disclosed techniques enable such performance measurements using one or more instances of a performance calculator. Specifically, the performance calculator 144₁ receives the stimulus vectors representing the shown plurality of stimuli (e.g., historical stimuli 162, recommended stimuli 172, and updated stimuli 182), and the response vectors representing the shown plurality of responses (e.g., historical responses 163, predicted responses 173, and measured responses 183) are used to calculate and present a set of performance results 150. Various sets of historical performance values (e.g., simulated historical performance values), recommended performance values, and/or measured performance values can be used to measure effectiveness or importance. Various sets of historical performance values (e.g., simulated historical performance values), recommended performance values, and/or measured performance values can be used to produce the performance results 150. More specifically, in one or more embodiment, a set of response metrics (e.g., measured and predicted responses 153) and a set of performance metrics (e.g., measured and predicted performance metrics 154) can be provided for comparison, and/or to generate effectiveness values. The performance values generated by the performance calculator 144₁ can provide information comprising a set of performance feedback 145 for use in determining the recommended stimuli 172 and/or the updated stimuli 182. For example, such feedback can be responsive to the performance calculator 144₁ receiving the measured responses 183 (e.g., measured response vectors) over the Internet.

Such techniques for determining media spend apportionment performance disclosed herein address deficiency issues with legacy approaches by providing true channel attribution and performance limitations (e.g., by using the stimulus response predictive model 190), and near real-time performance feedback and performance driver discernment (e.g., by using the performance calculator 144₁). An environment for determining media spend apportionment performance is discussed in FIG. 1B.

FIG. 1B depicts an environment 1B00 in which embodiments of the present disclosure can operate. As an option, one or more instances of environment 1B00 or any aspect thereof may be implemented in the context of the architecture and functionality of the embodiments described herein. Also, the environment 1B00 or any aspect thereof may be implemented in any desired environment.

As shown in FIG. 1B, the environment 1B00 comprises various computing systems (e.g., servers and devices) interconnected by a network 108. The network 108 can comprise any combination of a wide area network (e.g., WAN), local area network (e.g., LAN), cellular network, wireless LAN (e.g., WLAN), or any such means for enabling communication of computing systems. The network 108 can also be referred to as the Internet. More specifically, environment 1B00 comprises at least one instance of a measurement server 1301, at least one instance of an apportionment server 140₁, at least one instance of an ad server 106, at least one instance of a management interface 118₁ (e.g., operated by marketing manager represented by a manager 104₁), and a set of databases 120 (e.g., content 123, ads 126, stimulus data 127, response data 128, planning data 124, model data 125, etc.). The servers and devices shown in environment 1B00 can represent any single computing system with dedicated hardware and software, multiple computing systems clustered together (e.g., a server farm, a host farm, etc.), a portion of shared resources on one or more computing systems (e.g., a virtual server), or any combination thereof. Further, the network 108 includes signals comprising data and commands exchanged by and among the aforementioned computing devices and/or by and among any intermediate hardware devices used to transmit the signals. In one or more embodiments, the ad server 106 can represent an entity (e.g., campaign execution provider) in an online advertising ecosystem that might facilitate the deploying of updated stimuli represented by deployed stimulus vectors identified according to the herein disclosed techniques.

The environment 1B00 further comprises at least one instance of a user device 102₁ that can represent one of a variety of other computing devices (e.g., a smart phone 102₂, a tablet 102₃, a wearable 102₄, a laptop 102₅, a workstation 102₆, etc.) having software (e.g., a browser, mobile application, etc.) and hardware (e.g., a graphics processing unit, display, monitor, etc.) capable of processing and displaying information (e.g., web page, graphical user interface, etc.) on a display. The user device 102₁ can further communicate information (e.g., web page request, user activity, electronic files, computer files, etc.) over the network 108. The user device 102₁ can be operated by a user 103_{N}. Other users (e.g., user 103₁) with or without a corresponding user device can comprise the audience 164₃.

The users comprising the audience 164₃ can experience a plurality of content (e.g., content 123) provided by a plurality of content providers through any of a plurality of channels (e.g., online display, TV, radio, print, etc.). For example, a certain channel may provide any number of touchpoints (e.g., online display ads, paid search results, etc.) that comprise the stimuli for the respective channel. Such touchpoints can be configured to have various attributes so as to reach a certain portion of the audience. Specifically, as shown, the ad server 106 can deliver certain advertising stimuli (e.g., see message 112₁, message 112₂, and message 112_{N}) to the audience 164₃ through certain media channels (e.g., see channel1 110₁, channel2 110₂, and channelN 110_{N}, respectively) according to one or more marketing campaigns. Strictly as an example, the ad server 106 can select a particular advertisement from the corpus of ads 126 (e.g., creative provided by an advertiser) and can generate an impression (e.g., content plus the advertisement), which can serve as a touchpoint to be presented to targeted users (e.g., individual users within the audience 164₃) on their respective user devices.

Certain users in the audience 164₃ can interact with the stimuli (e.g., see operation 114₁, operation 114₂, and operation 114_{N}) to produce responses that can be detected by the ad server 106 and/or another component in the online advertising ecosystem (e.g., see message 116₁, message 116₂, and message 116_{N}). For example, a channel data provider can receive the impression data (e.g., stimulus vectors) and conversion data (e.g., response vectors) via network 108. The collected data can be stored in a database of stimuli (e.g., stimulus data 127) and a database of responses (e.g., response data 128), which in turn are made accessible by the measurement server 130₁ and/or the apportionment server 140₁. Operations performed by the measurement server 130₁ and the apportionment server 140₁ can vary widely by embodiment. As shown, in one or more embodiments, the measurement server 130₁ and/or the apportionment server 140₁ can include respective performance calculators (performance calculator 144₂, performance calculator 144₃, etc.). In one or more embodiments, the apportionment server 140₁ can also collect and store various planning data (e.g., apportionment plans, marketing budgets, etc.) in a database or other dataset (e.g., see planning data 124). In one or more embodiments, the measurement server 130₁ can further generate and store data for various models (e.g., stimulus response predictive model 190, etc.) in a database (e.g., model data 125).

Several partitioning possibilities of the components of environment 1B00 are discussed infra.

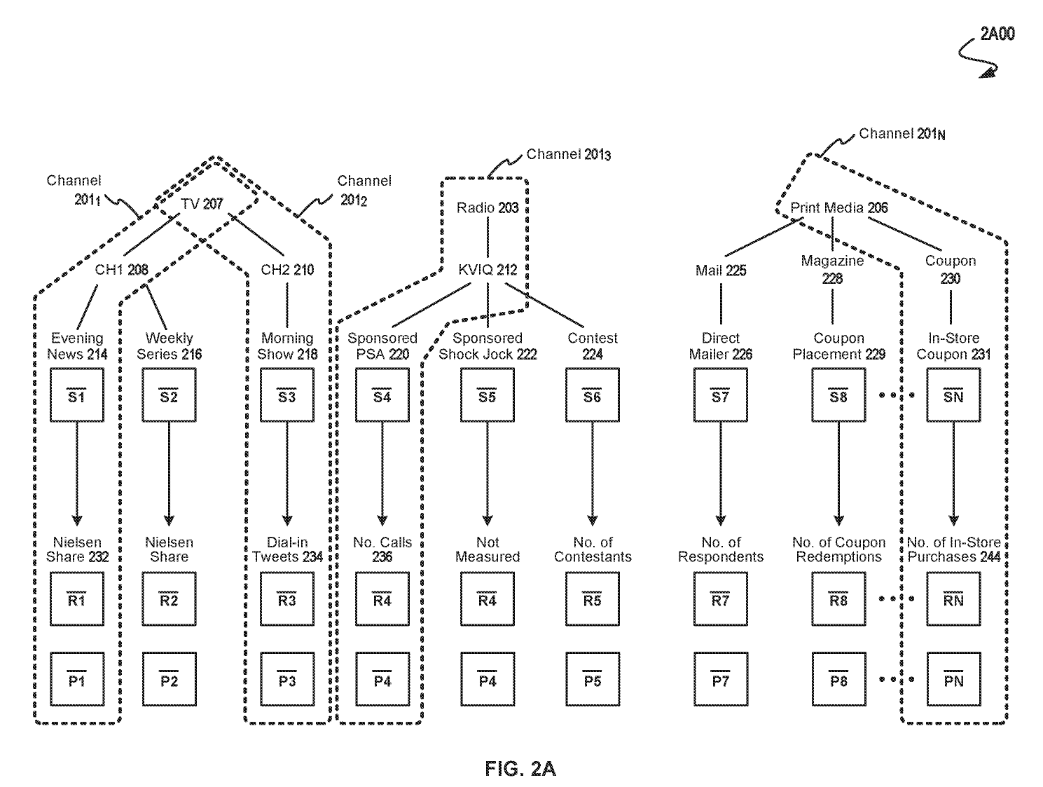

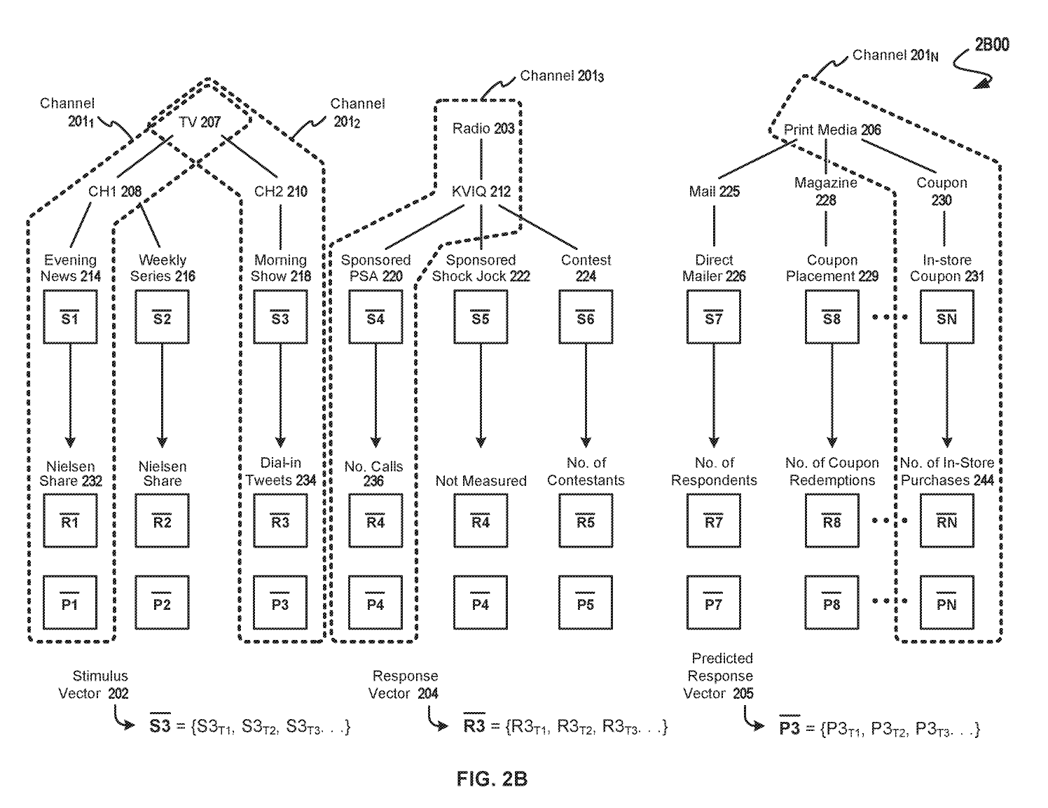

FIG. 2A presents a portfolio schematic 2A00 showing multiple channels as used in systems for determining media spend apportionment performance. As an option, one or more instances of portfolio schematic 2A00 or any aspect thereof may be implemented in the context of the architecture and functionality of the embodiments described herein. Also, the portfolio schematic 2A00 or any aspect thereof may be implemented in any desired environment.

As shown, the portfolio schematic 2A00 includes three types of media, namely TV 207, radio 203, and print media 206. Under each media type are shown one or more channels (e.g., channel 201₁, channel 201₂, channel 201₃, . . . , channel 201_{N}) and/or touchpoints (e.g., TV spots, radio spots, etc.) to which media spend can be apportioned. Other types of media (e.g., online display, online search, mobile advertising, email, etc.) and/or touchpoints (e.g., impressions, display ads, downloads, surveys, etc.) are possible. The shown TV 207 spends comprise stations named CH1 208 and named CH2 210. Radio 203 spends comprise a station named KVIQ 212. Spending on print media 206 and/or spends on mail 225 can include costs of distribution through direct mail 226, magazine 228, and printed coupon 230.

For each media shown, there is one or more stimuli (e.g., S̅1̅, S̅2̅, S̅3̅, . . . , S̅N̅) and its respective measured response (e.g., R̅1̅, R̅2̅, R̅3̅, . . . , R̅N̅) and/or predicted response (e.g., P̅1̅, P̅2̅, P̅3̅, . . . , P̅N̅). In some cases, a stimulus can comprise one or more touchpoints, and users can interact with such one or more touchpoints over time. In the example shown, there is a one-to-one correspondence between a particular stimulus and its measured and/or predicted response. As shown, the TV 207 and the spot shown as evening news 214 are depicted with stimulus S̅1̅, and have an associated measured response R̅1̅ (e.g., Nielsen share 232). The stimulus S̅1̅ can also have an associated predicted response P̅1̅ as provided by a stimulus response predictive model.

The shown media portfolio further includes spends for TV 207 during the evening news 214, weekly series 216, and morning show 218. The media portfolio also includes spends on radio 203 spends in the form of a sponsored public service announcement 220, a sponsored shock jock spot 222, and a contest 224. The media portfolio also includes spends for print media 206 spends for direct mailings, spends for a coupon placement 229, and spends for an in-store coupon 231.

The portfolio schematic 2A00 also shows a set of response measurements to be taken. Specifically, channel 201₁ includes a measurement using Nielsen share 232, channel 201₂ includes a measurement using dial-in tweets 234, and channel 201₃ includes a measurement using number of calls 236. Further, channel 201_{N} includes a measurement using number of in-store purchases 244. Using a stimulus response predictive model, a set of response predictions can also be determined from a set of stimuli (e.g., actual or hypothetical). The stimuli and responses discussed herein are often formed as a time-series of individual interactions with touchpoints and respective responses. For notational convenience a time-series is depicted as a vector. Some uses of stimulus vectors and response vectors are discussed in FIG. 2B.

FIG. 2B is a portfolio schematic 2B00 depicting stimulus and response vectors as used in systems for determining media spend apportionment performance. As an option, one or more instances of portfolio schematic 2B00 or any aspect thereof may be implemented in the context of the architecture and functionality of the embodiments described herein. Also, the portfolio schematic 2B00 or any aspect thereof may be implemented in any desired environment.

The shown vectors (e.g., stimulus vector 202, response vector 204, and predicted response vector 205) are comprised of a time-series of data items (e.g., touchpoint attributes, conversion indications, etc.). The time-series can be presented in a native time unit (e.g., weekly, daily) and can be apportioned over a different time unit. For example, stimulus S̅3̅ might correspond to a weekly spend for the morning show 218, even though the stimulus (e.g., touchpoint) to be considered actually occurs daily (e.g., during the “Morning Show”). In this case, the weekly stimulus spend can be apportioned to a daily stimulus occurrence. In some situations, the time unit in a time-series can be granular (e.g., by the minute). Apportionment over time periods or time units can be performed using any known techniques. Vectors (e.g., instances of stimulus vector 202, instances of response vector 204, instances of predicted response vector 205, etc.) can be formed from any time-series in any time unit and can be apportioned to another time-series using any other time unit.

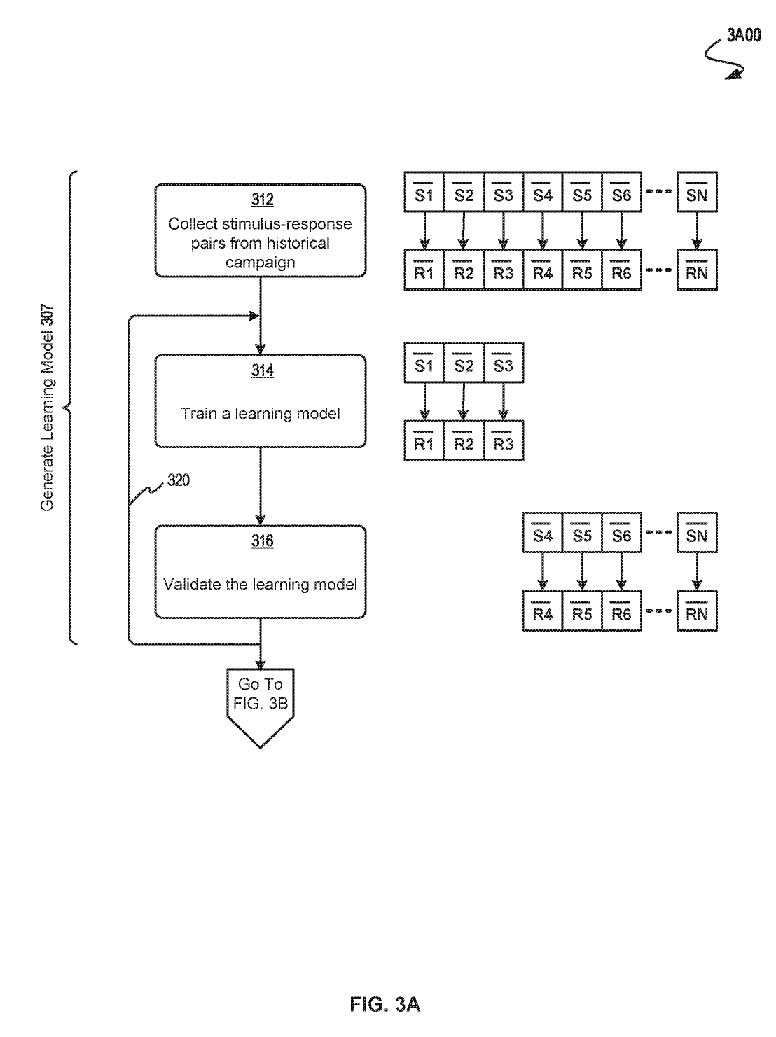

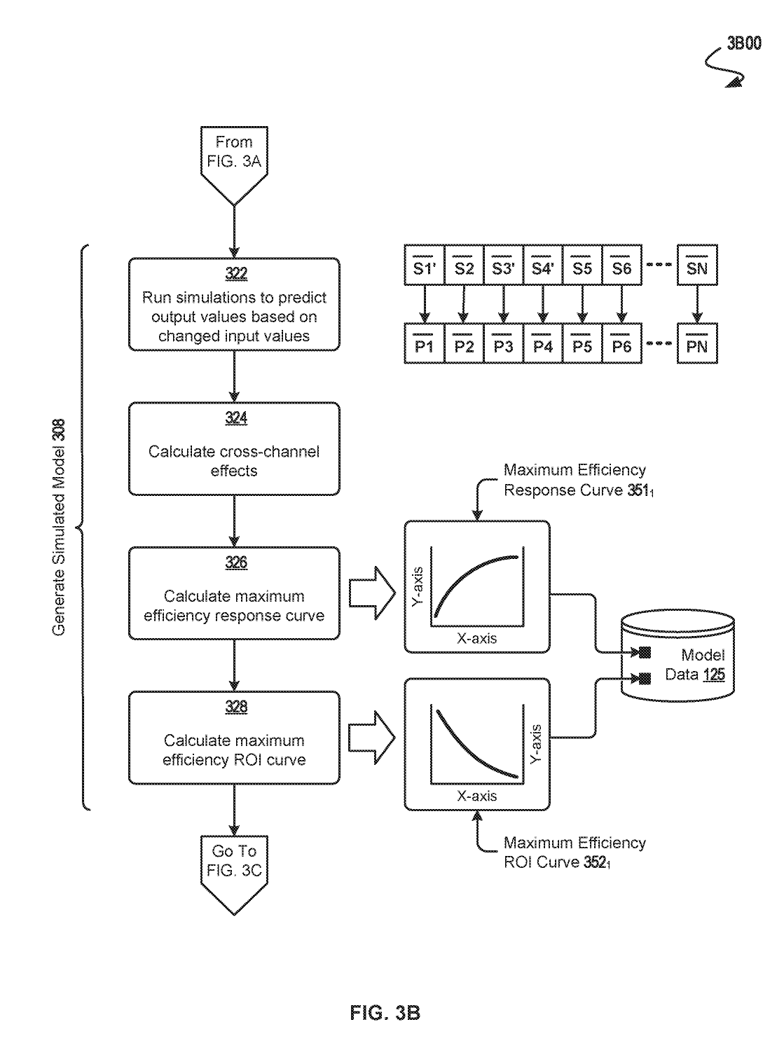

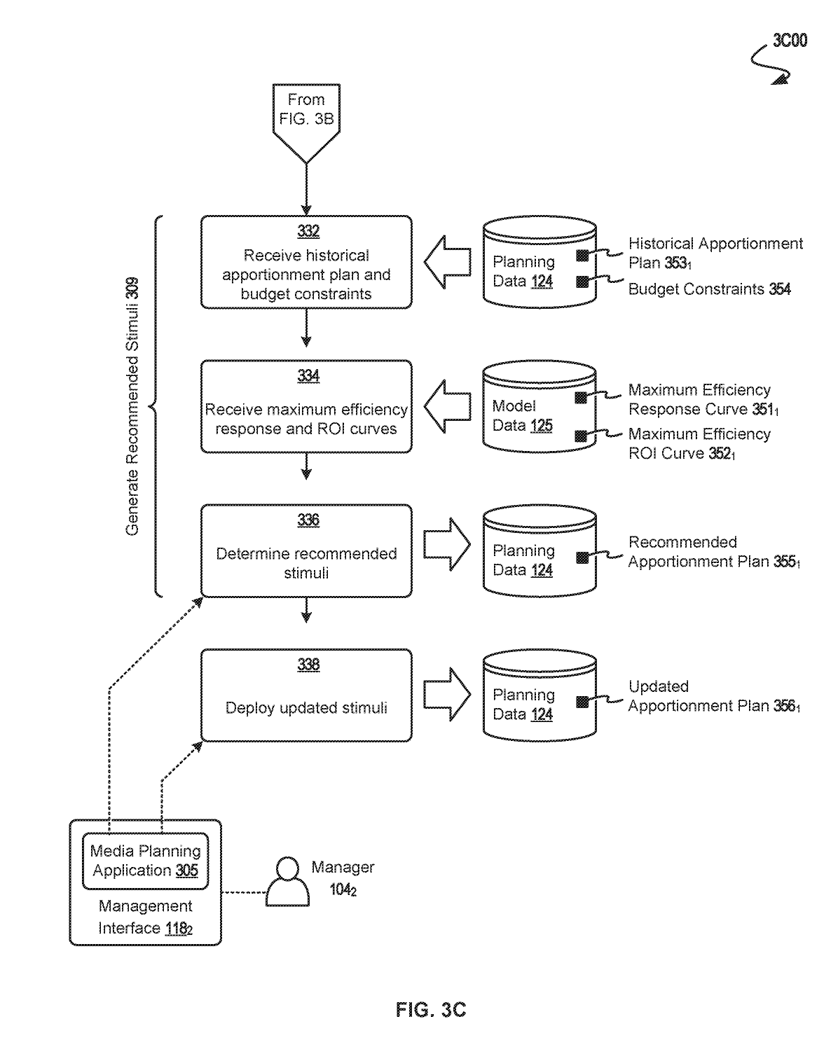

A flow for generating and collecting the stimulus, response, and predicted response data for determining media spend apportionment performance according to the herein disclosed techniques are described in FIG. 3A, FIG. 3B, and FIG. 3C.

FIG. 3A depicts a learning model development flow 3A00 as used in systems for determining media spend apportionment performance. As an option, one or more instances of learning model development flow 3A00 or any aspect thereof may be implemented in the context of the architecture and functionality of the embodiments described herein. Also, the learning model development flow 3A00 or any aspect thereof may be implemented in any desired environment.

FIG. 3A depicts process steps used in the generation of a learning model (see grouping of steps to generate learning model 307) according to the herein disclosed techniques. Such learning models can be included in a stimulus response predictive model. As shown, stimulus vectors S̅1̅ through S̅N̅ and response vectors R̅1̅ through R̅N̅ from a historical marketing campaign can be collected and organized into one-to-one pairings (see operation 312). A portion of the collected pairs (e.g., pairs S̅1̅-R̅1̅ through S̅3̅-R̅3̅) can be used to train one or more learning models (see operation 314). A different portion of the collected pairs (e.g., pairs S̅4̅-R̅4̅ through S̅N̅-R̅N̅) can be used to validate the learning model (see operation 316). The processes of training and validating can be iterated (see path 320) until the learning model behaves within target tolerances (e.g., with respect to predictive statistic metrics, descriptive statistics, significance tests, etc.). In some cases, additional historical stimulus-response pairs can be collected to further train the learning model. When the learning model has been generated, processing continues to operations depicted in FIG. 3B.

FIG. 3B depicts a simulated model development flow 3B00 as used in systems for determining media spend apportionment performance. As an option, one or more instances of simulated model development flow 3B00 or any aspect thereof may be implemented in the context of the architecture and functionality of the embodiments described herein. Also, the simulated model development flow 3B00 or any aspect thereof may be implemented in any desired environment.

FIG. 3B depicts process steps (e.g., simulated model development flow 3B00) used in the generation of a simulated model from a learning model (see grouping of steps to generate simulated model 308) according to the herein disclosed techniques. Such simulated models can be included in a stimulus response predictive model. The simulated model development flow 3B00 can include some or all of the following steps:
Run simulations with varying stimuli (e.g., simulated variations) using the learning model to predict responses associated with the varied stimuli (see operation 322).
Using the simulations of operation 322, observe and quantify the changes in the responses in other channels to calculate cross-channel effects (see operation 324). For example, and as shown, if only stimulus S̅3̅ is applied and varied across some range, the predicted response given as P̅4̅ can be captured to determine the effect of S̅3̅ on P̅4̅. More specifically, a predicted response in Channel 4 (e.g., P̅4̅) to a stimulus variation in Channel 3 (e.g., S̅3̅′) is deemed to be a cross-channel effect.
Further using the simulations of operation 322, calculate a maximum efficiency response curve 3511 for the media portfolio (see operation 326). For example, an exhaustive search algorithm can simulate all possible combinations of channel and/or touchpoint stimuli across a range of overall budget values (e.g., along the X-axis). The best predicted responses (e.g., along the Y-axis) associated with respective stimuli combinations at respective budget settings are used to form the maximum efficiency response curve 351₁. The data describing the maximum efficiency response curve 351₁ can be stored in model data 125. Various techniques and various X-axis and Y-axis scales and/or metrics can be used to form the maximum efficiency response curve 351₁.
Using the simulations of operation 322 and the maximum efficiency response curve 351 of operation 326, calculate a maximum efficiency ROI curve 352₁ for the media portfolio (see operation 328). For example, a performance calculator can determine one or more performance metrics (e.g., ROI value) for the respective data points of the maximum efficiency response curve 351₁. The data pairs of performance metrics (e.g., along the Y-axis) and respective budget settings (e.g., along the X-axis) can be used to form the maximum efficiency ROI curve 352₁. The data describing the maximum efficiency ROI curve 352₁ can be stored in model data 125. Various techniques and various X-axis and Y-axis scales and/or metrics can be used to form the maximum efficiency ROI curve 352₁.

When the simulated model has been generated, processing continues to operations depicted in FIG. 3C to generate recommended stimuli and deploy updated stimuli.

FIG. 3C depicts a recommended stimuli development flow 3C00 as used in systems for determining media spend apportionment performance. As an option, one or more instances of recommended stimuli development flow 3C00 or any aspect thereof may be implemented in the context of the architecture and functionality of the embodiments described herein. Also, the recommended stimuli development flow 3C00 or any aspect thereof may be implemented in any desired environment.

The shown recommended stimuli development flow 3C00 depicts one embodiment of certain process steps used in the generation of a set of recommended stimuli using previously generated models and data according to the herein disclosed techniques (see grouping of steps to generate recommended stimuli 309). The steps further depict the deployment of an updated stimuli plan. The flow shown in FIG. 3C can include some or all of the following steps:
Receive a historical apportionment plan 353₁ and a set of budget constraints 354 from planning data 124 (see operation 332).
Receive the maximum efficiency response curve 351₁ and maximum efficiency ROI curve 3521 from model data 125 (see operation 334).
Using the information received in operation 332 and operation 334, determine a set of recommended stimuli (see operation 336). In some cases, the set of recommended stimuli might be determined automatically (e.g., without user interaction) by systems implementing the herein disclosed techniques. In other cases, the set of recommended stimuli might be determined based, in part, on user interactions and/or input. For example, an application user (e.g., internal marketing manager, third-party marketing consultant, etc.) represented by manager 104₂ might interact (e.g., through a media planning application 305 on a management interface 118₂) with a stimulus response predictive model (e.g., comprising the learning model and the simulated model) to simulate various media spend apportionment scenarios given certain constraints (e.g., budget constraints 354, historical apportionment plan 353₁, etc.). The best performing (e.g., closest to the maximum efficiency response curve 351₁ and/or maximum efficiency ROI curve 352₁) simulated apportionment scenario can form a recommended apportionment plan 355₁ that can be stored in a database (e.g., planning data 124) or other dataset.
Using the recommended apportionment plan 355₁ and other known constraints, deploy a set of updated stimuli (see operation 338). In some cases, the set of updated stimuli might be determined automatically (e.g., without user interaction) by systems implementing the herein disclosed techniques. In other cases, the set of updated stimuli might be determined based, in part, on user interactions and/or input. For example, the manager 104₂ (e.g., or another marketing manager), can receive the recommended apportionment plan 355₁ and deploy the recommended apportionment plan 355₁ as an updated apportionment plan 356₁. In other examples, the manager 104₂ might modify the recommended apportionment plan 355₁ due to various constraints (e.g., seasonal, contractual, economic, time-related, etc.) and deploy a modified version of the recommended apportionment plan 355₁ as the updated apportionment plan 356₁. A selected (e.g., final, deployed) instance of updated apportionment plan 356₁ can be stored as planning data in a database (e.g., planning data 124) or other dataset.

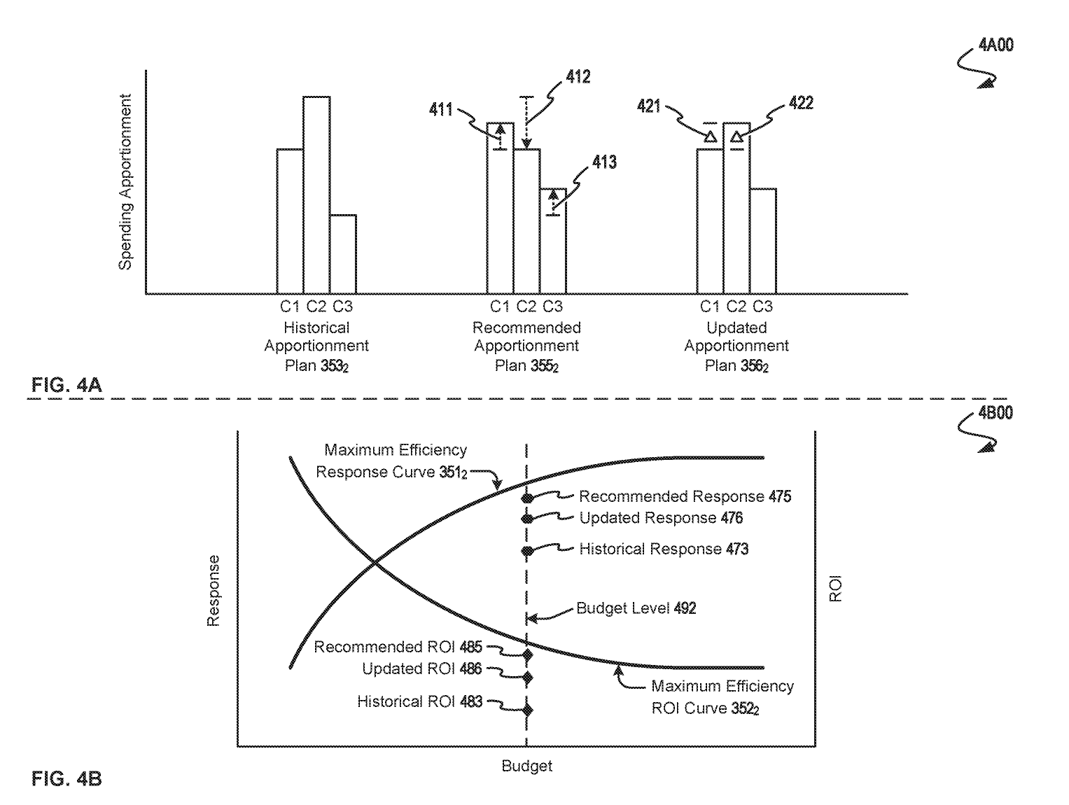

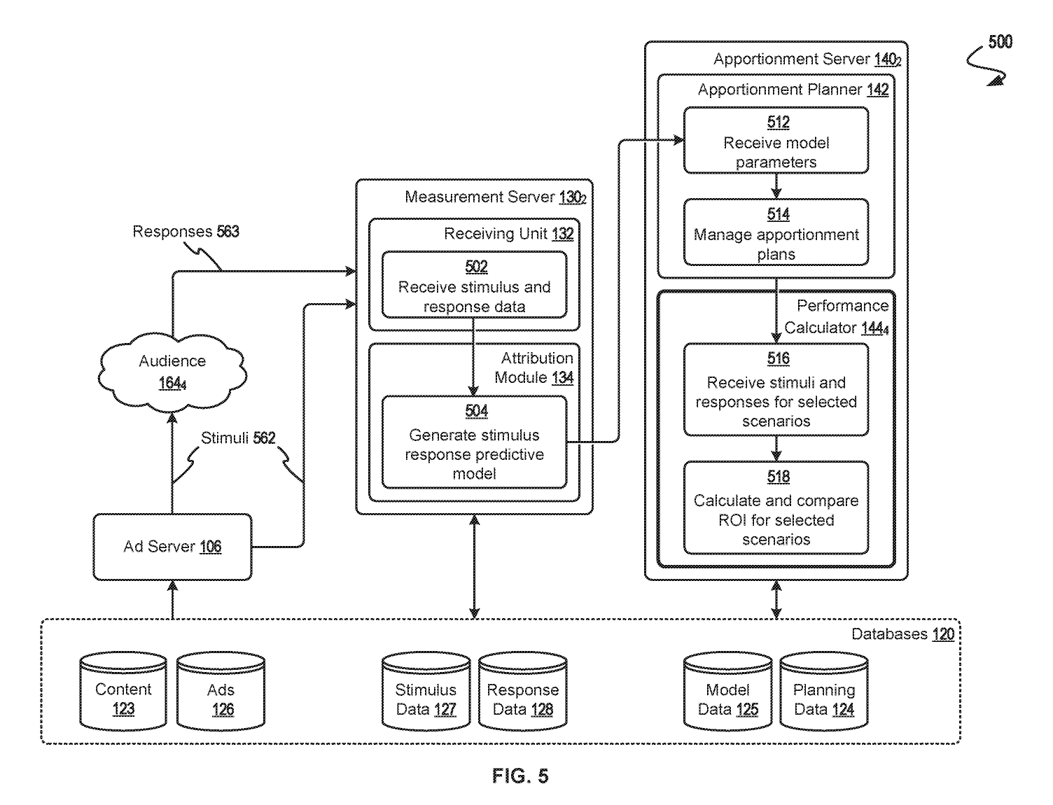

The techniques disclosed in FIG. 3A, FIG. 3B, and FIG. 3C depict an approach for collecting the stimulus, response, and predicted response data (e.g., stimulus vectors and response vectors) for determining media spend apportionment performance. FIG. 4A and FIG. 4B illustrate how such data can be used to calculate associated performance results for various media channel and/or touchpoint spending apportionment plans according to the herein disclosed techniques.

FIG. 4A depicts a chart 4A00 illustrating example media spend apportionment plans. As an option, one or more instances of chart 4A00 or any aspect thereof may be implemented in the context of the architecture and functionality of the embodiments described herein. Also, the chart 4A00 or any aspect thereof may be implemented in any desired environment.

As shown in chart 4A00, each group of bars represents a marketing campaign comprising three media channels (e.g., media channel C1, media channel C2, and media channel C3), for which channels a respective spending apportionment can be applied. The total of the respective channel spending apportionments for each group can represent a total budget for the marketing campaign. For example, a historical apportionment plan 353₂ might have been determined using any known technique, including any of the techniques presented hereunder, and was deployed to the marketplace such that historical data (e.g., historical stimulus vectors and historical response vectors) were collected and stored (e.g., in stimulus data 127 and response data 128, respectively). At some moment in time, the marketing manager might learn that one or more changes in spending allocation are needed. For example, TV programming might change suddenly (e.g., a series is canceled) and the previously planned spending apportioned to a sequence of TV ads for a TV program cannot be placed. In another example, the marketing manager might merely question whether the historical apportionment plan 353₂ is optimized for the target audience.

In such a case, a recommended apportionment plan 355₂ can be determined and presented to the marketing manager using any known technique, including any of the techniques presented hereunder. During the course of determining the recommended apportionment plan 355₂, data associated with the recommended apportionment plan (e.g., recommended stimulus vectors and predicted response vectors) can be collected and stored (e.g., in stimulus data 127 and response data 128, respectively). As shown, the recommended apportionment plan 355₂ comprises multiple adjustments from the historical apportionment plan 353₂ (e.g., see adjustment 411, adjustment 412, and adjustment 413). As an example, the adjustments have been determined (e.g., by stimulus response predictive model 190) to produce one or more desired effects on the marketing campaign response (e.g., improved performance). In the example shown, the total of the respective channel spending apportionments for the historical apportionment plan 353₂ and the recommended apportionment plan 355₂ can be the same (e.g., due to a fixed budget, or due to a contractual obligation).

At some later time, the marketing manager might be ready to deploy a new apportionment plan that is intended to have an improved performance (e.g., improved response and/or ROI). In some cases, the marketing manager might configure a system implementing the herein disclosed techniques to deploy the recommended apportionment plan 355₂ as a default instance of an updated apportionment plan 356₂ having no differences in stimuli spend apportionment as compared to that of the recommended apportionment plan 355₂. In other cases, the marketing manager might modify the recommended apportionment plan 355₂ due to various constraints (e.g., seasonal, contractual, economic, time-related, etc.) and deploy, for example, the updated apportionment plan 356₂ shown in chart 4A00. In the case shown, such constraints resulted in the updated apportionment plan 356₂ comprising multiple variations from the recommended apportionment plan 355₂ (e.g., see variation 421 and variation 422). When the updated apportionment plan 356₂ is deployed to the marketplace, various updated data (e.g., deployed stimulus vectors and measured response vectors) can be collected and stored (e.g., in stimulus data 127 and response data 128, respectively).

Using the measured and predicted stimulus and response data for the apportionment plans shown in FIG. 4A, updated performance values of the respective plans can be calculated and compared as described in FIG. 4B below.

FIG. 4B shows apportionment plan performance results 4B00 determined for various media spend apportionment plans, according to some embodiments. As an option, one or more instances of apportionment plan performance results 4B00 or any aspect thereof may be implemented in the context of the architecture and functionality of the embodiments described herein. Also, the apportionment plan performance results 4B00 or any aspect thereof may be implemented in any desired environment.

The apportionment plan performance results 4B00 represent the performance of the associated example media spend apportionment plans described in FIG. 4A. As shown, the apportionment plan performance results 4B00 can be plotted on an XY plot having a common X-axis scale (e.g., “Budget”) and multiple Y-axis scales (e.g., “Response” and “ROF”). The apportionment plan performance results 4B00 can further comprise a plurality of response data points (e.g., historical response 473, recommended response 475, and updated response 476) and a plurality of ROI values (e.g., historical ROI 483, recommended ROI 485, and updated ROI 486) along a vertical line representing a budget level 492. The historical response 473 and the historical ROI 483 correspond to the measured performance of the historical apportionment plan 353₂, the recommended response 475 and recommended ROI 485 correspond to the predicted performance of the recommended apportionment plan 355₂, and the updated response 476 and the updated ROI 486 correspond to the measured performance of the updated apportionment plan 356₂. A maximum efficiency response curve 3512 and a maximum efficiency ROI curve 352₂ that have been prior calculated (e.g., see FIG. 3B) can also be displayed as target performance references. For example, for a given marketing budget (e.g., budget level 492), a marketing manager might desire to apportion spending so as to achieve a performance (e.g., response and ROI) at or nearest a maximum level (e.g., the intersection of budget level 492 and the maximum efficiency response curve 351₂, and/or the intersection of budget level 492 and the maximum efficiency ROI curve 352₂).

More specifically, the marketing manager might observe the historical response 473 and/or historical ROI 483 and desire to discover a different apportionment that might improve the response and/or ROI, respectively, of the marketing campaign (e.g., move the response data point and/or ROI data point nearer the maximum efficiency response curve 351₂ and/or the maximum efficiency ROI curve 352₂, respectively). Using any of the techniques described herein, the recommended apportionment plan 355₂ that is predicted to yield the recommended response 475 and the recommended ROI 485 can be determined. An updated apportionment plan 356₂ based, in part, on the recommended apportionment plan 355₂, the recommended response 475, and/or the recommended ROI 485 can be deployed. The stimuli and responses corresponding to the updated apportionment plan 356₂ can be measured over a certain time duration (e.g., the same time duration used to determine the historical response 473 and the historical ROI 483) to determine the updated response 476 and the updated ROI 486.

If the stimuli of the updated apportionment plan 356₂ is the same as the stimuli of the recommended apportionment plan 355₂ (e.g., variation 421=0 and variation 422=0), then any difference between the updated response 476 and the recommended response 475, and/or any difference between the updated ROI 486 and the recommended ROI 485, might reflect a prediction error in the recommended performance metrics. In another case, if the stimuli of the updated apportionment plan 356₂ is not the same as the stimuli of the recommended apportionment plan 355₂ (e.g., variation 421≠0 and/or variation 422≠0), then any difference between the updated response 476 and the recommended response 475, and/or any difference between the updated ROI 486 and the recommended ROI 485, might reflect both a prediction error and the variation in stimuli. By incorporating all variables (e.g., stimuli, responses, measurement duration, etc.) for all apportionment plans into the performance metrics, the herein disclosed techniques enable discernment of the true performance improvement driver from measurement errors and/or prediction errors and/or other variables.

The apportionment plan performance results 4B00 presents merely one example and other variations are possible. For example, the “Response” scale shown can represent any response metric (e.g., conversions, revenue, etc.). Also, the “ROI” scale shown can represent any performance metric (e.g., ROAS, conversions per spend, etc.). Further, the “Budget” scale shown can represent any metric (e.g., spend, impressions, etc.).

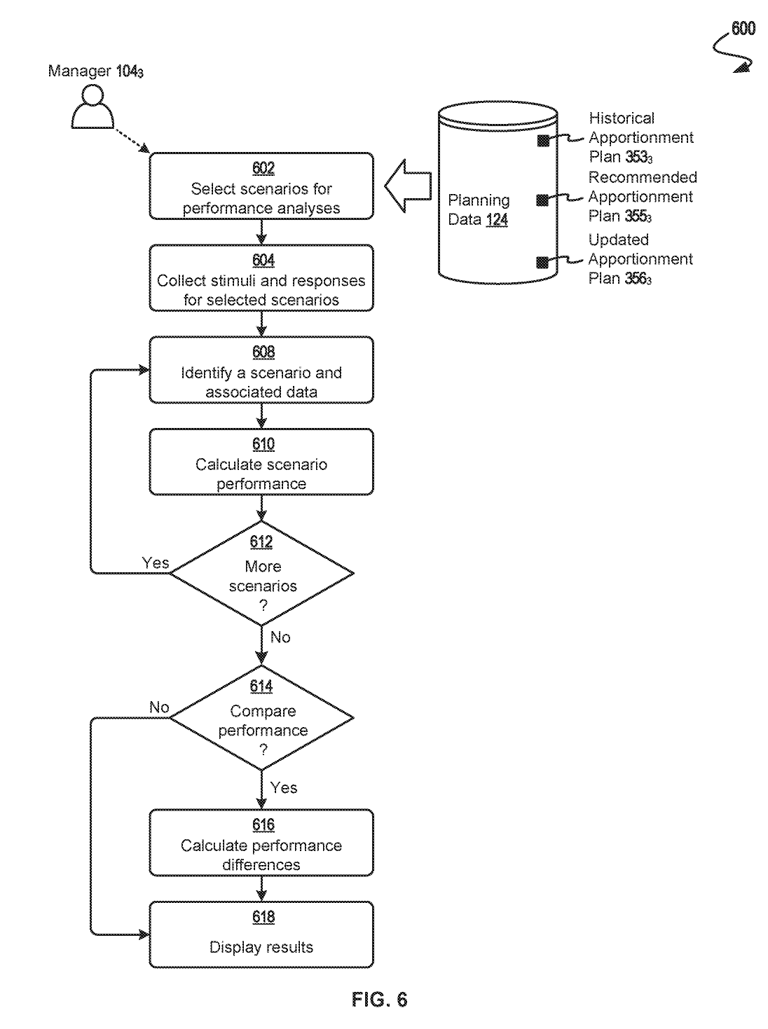

FIG. 5 depicts a subsystem 500 for determining media spend apportionment performance, according to some embodiments. As an option, one or more instances of subsystem 500 or any aspect thereof may be implemented in the context of the architecture and functionality of the embodiments described herein. Also, the subsystem 500 or any aspect thereof may be implemented in any desired environment.

As shown, a plurality of content 123 and corpus of ads 126 can be presented by the ad server 106 as a set of stimuli 562 to an audience 164₄ to undergo a plurality of user interactions to produce a set of responses 563. A receiving unit 132 in the measurement server 130₂ can receive the stimulus and response data (see operation 502). Such data can be used by an attribution module 134 to generate a stimulus response predictive model (see operation 504). The measured stimulus and response data, and any simulated stimuli and predicted responses (e.g., from attribution module 134) can be stored in one or more databases (e.g., stimulus data 127 and response data 128).

In the context of a media campaign, subsystem 500 can further serve to determine media spend apportionment performance. As shown, an apportionment planner 142 implemented in the apportionment server 140₂ can receive the model parameters from the attribution module 134 in the measurement server 130₂ (see operation 512). The apportionment planner 142 can further enable a marketing manager to manage one or more apportionment plans (see operation 514). For example, the marketing manager might use a media planning application to access the stimulus response predictive model for adjusting a recommended apportionment plan to determine an updated apportionment plan with improved performance (e.g., as confirmed by updated performance values). The performance calculator 144₄ facilitates such apportionment planning by calculating the measured and/or predicted performance of various selected apportionment scenarios. Specifically, the performance calculator 144₄ can receive the measured and/or predicted stimuli and responses for a set of selected scenarios (see operation 516) and can calculate and compare one or more performance metrics (e.g., ROI) of the selected scenarios (see operation 518).

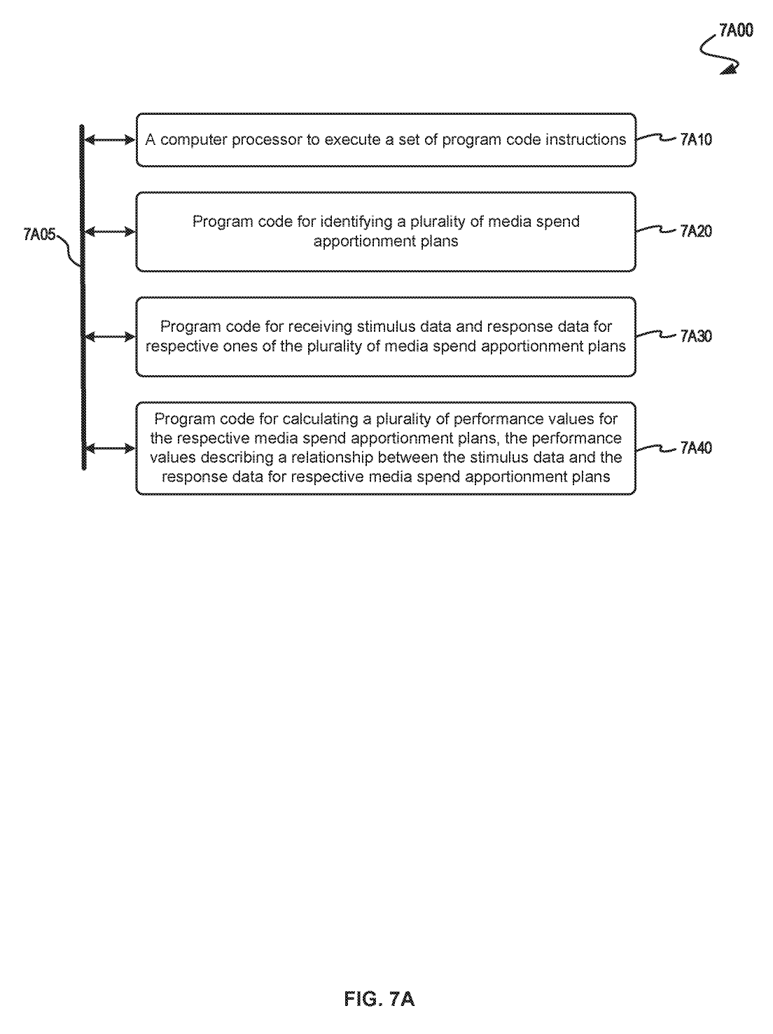

The subsystem 500 presents merely one partitioning. The specific example shown where a measurement server 130₂ comprises a receiving unit 132 and an attribution module 134, and where an apportionment server 140₂ comprises an apportionment planner 142 and a performance calculator 144₄ is purely exemplary, and other partitioning is reasonable, and the partitioning may be defined in part by the volume of empirical data. In some cases, one or more instances of a database engine associated with the databases 120 serves to perform calculations (e.g., within, or in conjunction with, a database engine query). A technique for determining media spend apportionment performance can be implemented in any of a wide variety of systems. One such system can be depicted in a flowchart, an example of which is shown and described as pertaining to FIG. 6.

FIG. 6 depicts a flowchart 600 for determining media spend apportionment performance, according to some embodiments. As an option, one or more instances of flow chart 600 or any aspect thereof may be implemented in the context of the architecture and functionality of the embodiments described herein. Also, the flowchart 600 or any aspect thereof may be implemented in any desired environment.

As shown, a set of apportionment scenarios (e.g., historical apportionment plan 353₃, recommended apportionment plan 355₃, and updated apportionment plan 356₃) can be selected for performance analyses (see operation 602). For example, a manager 104₃ might select one or more of the apportionment scenarios from the planning data 124. The measured and/or predicted stimuli and responses (e.g., stimulus vectors and response vectors) for the selected scenarios can be collected (see operation 604). For each scenario in the group of selected scenarios, a scenario and its associated stimulus and response data can be identified (see operation 608), and the scenario performance (e.g., performance values) can be calculated (see operation 610). Various performance metrics (e.g., ROI, ROAS, etc.) and definitions (e.g., campaign-specific ROI definitions) are possible. For example, a marketing manager might analyze the performance of a campaign with an engagement objective (e.g., number of users having brand awareness per spend) differently than a campaign with a conversion objective (e.g., product revenue per spend).

Returning to flowchart 600, a selector 612 determines if more scenarios in the group of selected scenarios are to be identified for performance calculation. If more scenarios exist, the flow can return to operation 608. If all scenarios have been analyzed, the flow can continue to a selector 614 to determine if the performance calculations for the group of scenarios are to be compared. As earlier mentioned, comparison of performance metrics can enable discernment of the true performance drivers from measurement errors and/or prediction errors and/or other variables. If the performance comparison is desired, the differences among the performance values and/or metrics from the respective scenarios in the group of selected scenarios can be calculated to determine a set of difference values (see operation 616), and the results of the performance calculations and performance comparison calculations (e.g., difference values) are displayed (see operation 618). If the performance comparison is not desired, operation 616 is not performed and the results of the performance calculations is displayed (see operation 618). In some cases, operation 618 can further display a maximum efficiency response curve and a maximum efficiency performance curve (e.g., maximum efficiency response curve 351₂ and maximum efficiency ROI curve 352₂, respectively) that have been calculated (e.g., see FIG. 3B) to serve as target performance references.

### Additional Practical Application Examples

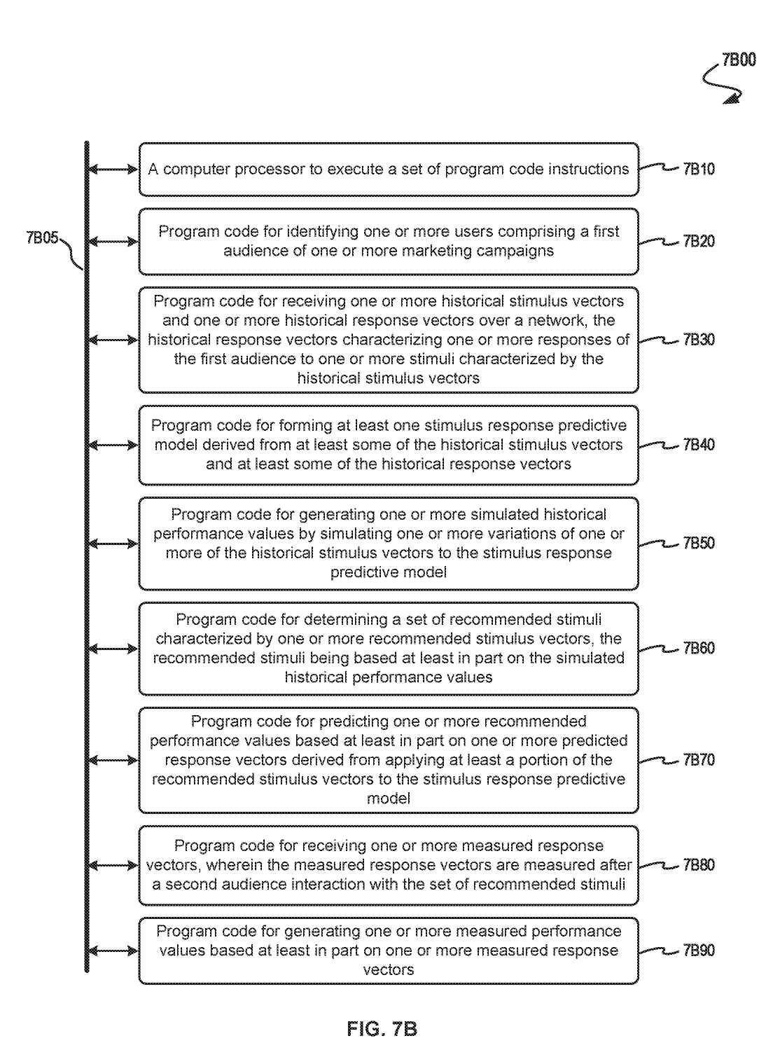

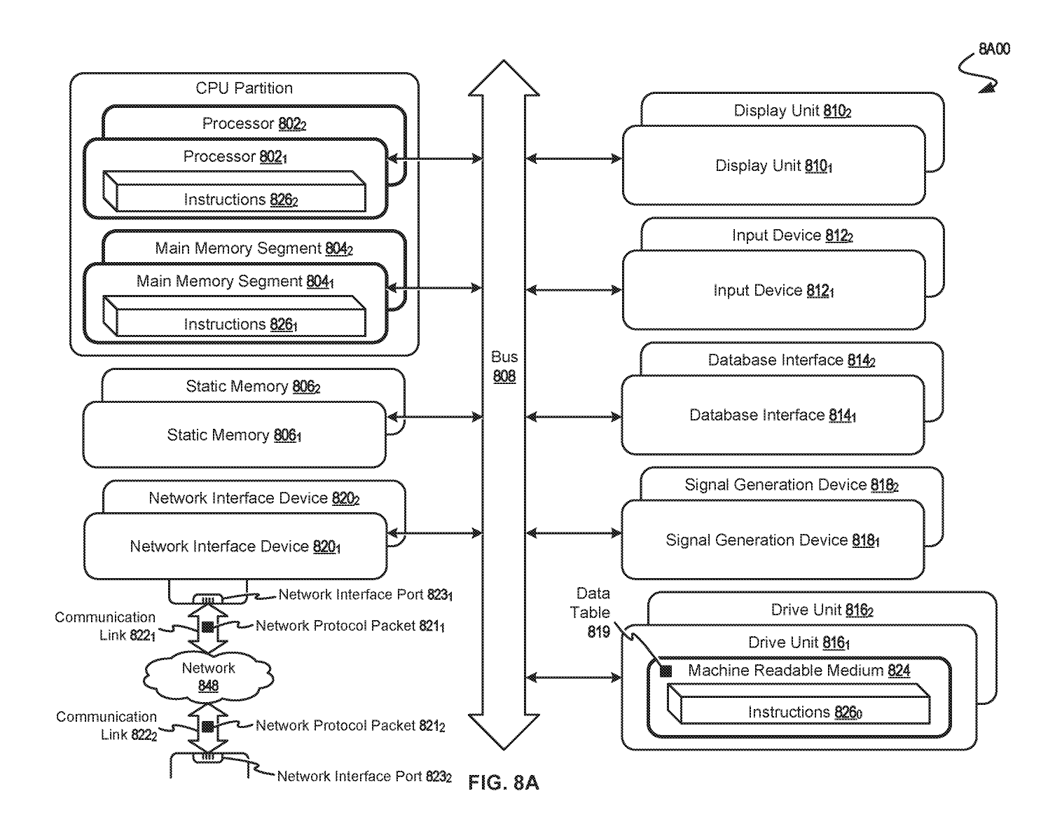

FIG. 7A is a block diagram of a system 7A00 for determining media spend apportionment performance. As shown, system 7A00 comprises at least one processor and at least one memory, the memory serving to store program instructions corresponding to the operations of the system.

As shown, an operation can be implemented in whole or in part using program instructions accessible by a module. The modules are connected to a communication path 7A05, and any operation can communicate with other operations over communication path 7A05. The modules of the system can, individually or in combination, perform method operations within system 7A00. Any operations performed within system 7A00 may be performed in any order unless as may be specified in the claims.

The embodiment of FIG. 7A implements a portion of a computer system, shown as system 7A00, comprising a computer processor to execute a set of program code instructions (see module 7A10) and modules for accessing memory to hold program code instructions to perform: identifying a plurality of media spend apportionment plans (see module 7A20); receiving stimulus data and response data for respective ones of the plurality of media spend apportionment plans (see module 7A30); and calculating a plurality of performance values for the respective media spend apportionment plans, the performance values describing a relationship between the stimulus data and the response data for respective media spend apportionment plans (see module 7A40).

FIG. 7B is a block diagram of a system 7B00 for determining media spend apportionment performance. As shown, system 7B00 comprises at least one processor and at least one memory, the memory serving to store program instructions corresponding to the operations of the system. As an option, the system 7B00 may be implemented in the context of the architecture and functionality of the embodiments described herein. Of course, however, the system 7B00 or any operation therein may be carried out in any desired environment.

The system 7B00 comprises at least one processor and at least one memory, the memory serving to store program instructions corresponding to the operations of the system. As shown, an operation can be implemented in whole or in part using program instructions accessible by a module. The modules are connected to a communication path 7B05, and any operation can communicate with other operations over communication path 7B05. The modules of the system can, individually or in combination, perform method operations within system 7B00. Any operations performed within system 7B00 may be performed in any order unless as may be specified in the claims.

The shown embodiment implements a portion of a computer system, presented as system 7B00, comprising a computer processor to execute a set of program code instructions (see module 7B10) and modules for accessing memory to hold program code instructions to perform: identifying one or more users comprising a first audience of one or more marketing campaigns (see module 7B20); receiving one or more historical stimulus vectors and one or more historical response vectors over a network, the historical response vectors characterizing one or more responses of the first audience to one or more stimuli characterized by the historical stimulus vectors (see module 7B30); forming at least one stimulus response predictive model derived from at least some of the historical stimulus vectors and at least some of the historical response vectors (see module 7B40); generating one or more simulated historical performance values by simulating one or more variations of one or more of the historical stimulus vectors to the stimulus response predictive model (see module 7B50); determining a set of recommended stimuli characterized by one or more recommended stimulus vectors, the recommended stimuli being based at least in part on the simulated historical performance values (see module 7B60); predicting one or more recommended performance values based at least in part on one or more predicted response vectors derived from applying at least a portion of the recommended stimulus vectors to the stimulus response predictive model (see module 7B70); receiving one or more measured response vectors, wherein the measured response vectors are measured after a second audience interaction with the set of recommended stimuli (see module 7B80); and generating one or more measured performance values based at least in part on one or more of the measured response vectors (see module 7B90).

### Additional System Architecture Examples

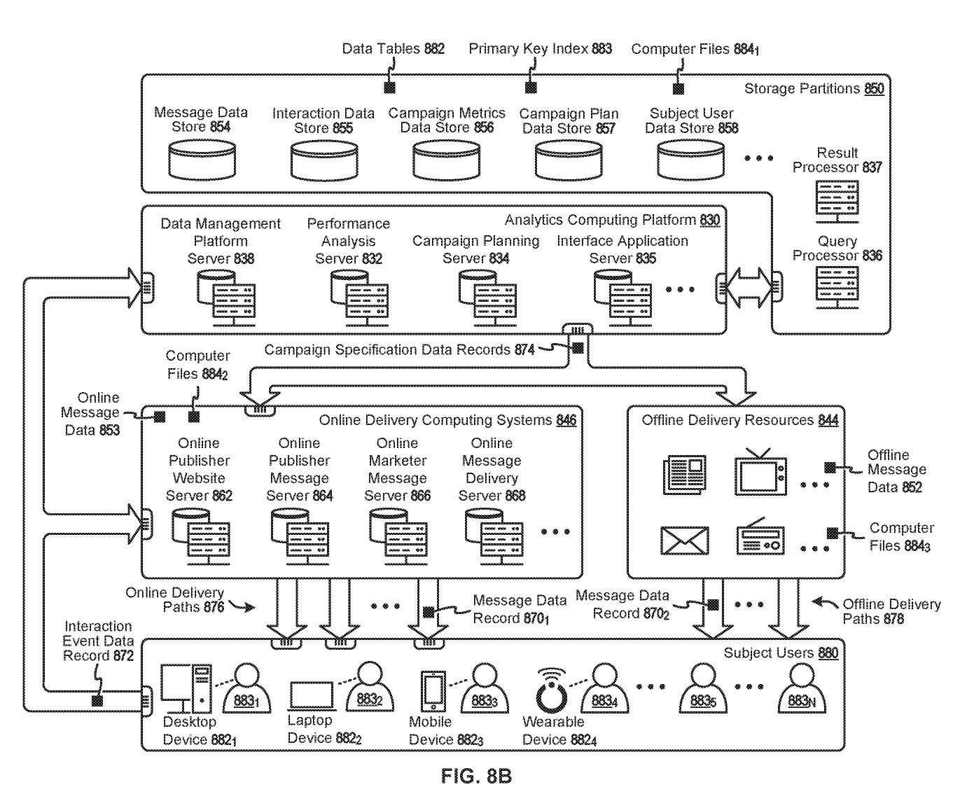

FIG. 8A depicts a diagrammatic representation of a machine in the exemplary form of a computer system 8A00 within which a set of instructions, for causing the machine to perform any one of the methodologies discussed above, may be executed. In alternative embodiments, the machine may comprise a network router, a network switch, a network bridge, Personal Digital Assistant (PDA), a cellular telephone, a web appliance or any machine capable of executing a sequence of instructions that specify actions to be taken by that machine.

The computer system 8A00 includes one or more processors (e.g., processor 802₁, processor 802₂, etc.), a main memory comprising one or more main memory segments (e.g., main memory segment 804₁, main memory segment 804₂, etc.), one or more static memories (e.g., static memory 806₁, static memory 806₂, etc.), which communicate with each other via a bus 808. The computer system 8A00 may further include one or more video display units (e.g., display unit 810₁, display unit 810₂, etc.), such as an LED display, or a liquid crystal display (LCD), or a cathode ray tube (CRT). The computer system 8A00 can also include one or more input devices (e.g., input device 812₁, input device 812₂, alphanumeric input device, keyboard, pointing device, mouse, etc.), one or more database interfaces (e.g., database interface 814₁, database interface 814₂, etc.), one or more disk drive units (e.g., drive unit 816₁, drive unit 816₂, etc.), one or more signal generation devices (e.g., signal generation device 818₁, signal generation device 818₂, etc.), and one or more network interface devices (e.g., network interface device 820₁, network interface device 820₂, etc.).

The disk drive units can include one or more instances of a machine-readable medium 824 on which is stored one or more instances of a data table 819 to store electronic information records. The machine-readable medium 824 can further store a set of instructions 826₀ (e.g., software) embodying any one, or all, of the methodologies described above. A set of instructions 826₁ can also be stored within the main memory (e.g., in main memory segment 804₁). Further, a set of instructions 826₂ can also be stored within the one or more processors (e.g., processor 802₁). Such instructions and/or electronic information may further be transmitted or received via the network interface devices at one or more network interface ports (e.g., network interface port 823₁, network interface port 823₂, etc.). Specifically, the network interface devices can communicate electronic information across a network using one or more optical links, Ethernet links, wireline links, wireless links, and/or other electronic communication links (e.g., communication link 822₁, communication link 822₂, etc.). One or more network protocol packets (e.g., network protocol packet 821₁, network protocol packet 821₂, etc.) can be used to hold the electronic information (e.g., electronic data records) for transmission across an electronic communications network (e.g., network 848). In some embodiments, the network 848 may include, without limitation, the web (i.e., the Internet), one or more local area networks (LANs), one or more wide area networks (WANs), one or more wireless networks, and/or one or more cellular networks.

The computer system 8A00 can be used to implement a client system and/or a server system, and/or any portion of network infrastructure.

It is to be understood that various embodiments may be used as or to support software programs executed upon some form of processing core (such as the CPU of a computer) or otherwise implemented or realized upon or within a machine or computer readable medium. A machine-readable medium includes any mechanism for storing or transmitting information in a form readable by a machine (e.g., a computer). For example, a machine-readable medium includes read-only memory (ROM); random access memory (RAM); magnetic disk storage media; optical storage media; flash memory devices; or any other type of non-transitory media suitable for storing or transmitting information.

A module as used herein can be implemented using any mix of any portions of the system memory, and any extent of hard-wired circuitry including hard-wired circuitry embodied as one or more processors (e.g., processor 802₁, processor 802₂, etc.).

FIG. 8B depicts a block diagram of a data processing system suitable for implementing instances of the herein-disclosed embodiments. The data processing system may include many more or fewer components than those shown.

The components of the data processing system may communicate electronic information (e.g., electronic data records) across various instances and/or types of an electronic communications network (e.g., network 848) using one or more electronic communication links (e.g., communication link 822₁, communication link 822₂, etc.). Such communication links may further use supporting hardware, such as modems, bridges, routers, switches, wireless antennas and towers, and/or other supporting hardware. The various communication links transmit signals comprising data and commands (e.g., electronic data records) exchanged by the components of the data processing system, as well as any supporting hardware devices used to transmit the signals. In some embodiments, such signals are transmitted and received by the components at one or more network interface ports (e.g., network interface port 823₁, network interface port 823₂, etc.). In one or more embodiments, one or more network protocol packets (e.g., network protocol packet 821₁, network protocol packet 821₂, etc.) can be used to hold the electronic information comprising the signals.

As shown, the data processing system can be used by one or more advertisers to target a set of subject users 880 (e.g., user 883₁, user 883₂, user 883₃, user 883₄, user 883₅, to user 883_{N}) in various marketing campaigns. The data processing system can further be used to determine, by an analytics computing platform 830, various characteristics (e.g., performance metrics, etc.) of such marketing campaigns. Other operations, transactions, and/or activities associated with the data processing system are possible. Specifically, the subject users 880 can receive a plurality of online message data 853 transmitted through any of a plurality of online delivery paths 876 (e.g., online display, search, mobile ads, etc.) to various computing devices (e.g., desktop device 882₁, laptop device 882₂, mobile device 882₃, and wearable device 882₄). The subject users 880 can further receive a plurality of offline message data 852 presented through any of a plurality of offline delivery paths 878 (e.g., TV, radio, print, direct mail, etc.). The online message data 853 and/or the offline message data 852 can be selected for delivery to the subject users 880 based in part on certain instances of campaign specification data records 874 (e.g., established by the advertisers and/or the analytics computing platform 830). For example, the campaign specification data records 874 might comprise settings, rules, taxonomies, and other information transmitted electronically to one or more instances of online delivery computing systems 846 and/or one or more instances of offline delivery resources 844. The online delivery computing systems 846 and/or the offline delivery resources 844 can receive and store such electronic information in the form of instances of computer files 884₂ and computer files 884₃, respectively. In one or more embodiments, the online delivery computing systems 846 can comprise computing resources such as an online publisher website server 862, an online publisher message server 864, an online marketer message server 866, an online message delivery server 868, and other computing resources. For example, the message data record 870₁ presented to the subject users 880 through the online delivery paths 876 can be transmitted through the communications links of the data processing system as instances of electronic data records using various protocols (e.g., HTTP, HTTPS, etc.) and structures (e.g., JSON), and rendered on the computing devices in various forms (e.g., digital picture, hyperlink, advertising tag, text message, email message, etc.). The message data record 870₂ presented to the subject users 880 through the offline delivery paths 878 can be transmitted as sensory signals in various forms (e.g., printed pictures and text, video, audio, etc.).

The analytics computing platform 830 can receive instances of an interaction event data record 872 comprising certain characteristics and attributes of the response of the subject users 880 to the message data record 870₁, the message data record 870₂, and/or other received messages. For example, the interaction event data record 872 can describe certain online actions taken by the users on the computing devices, such as visiting a certain URL, clicking a certain link, loading a web page that fires a certain advertising tag, completing an online purchase, and other actions. The interaction event data record 872 may also include information pertaining to certain offline actions taken by the users, such as purchasing a product in a retail store, using a printed coupon, dialing a toll-free number, and other actions. The interaction event data record 872 can be transmitted to the analytics computing platform 830 across the communications links as instances of electronic data records using various protocols and structures. The interaction event data record 872 can further comprise data (e.g., user identifier, computing device identifiers, timestamps, IP addresses, etc.) related to the users and/or the users' actions.

The interaction event data record 872 and other data generated and used by the analytics computing platform 830 can be stored in one or more storage partitions 850 (e.g., message data store 854, interaction data store 855, campaign metrics data store 856, campaign plan data store 857, subject user data store 858, etc.). The storage partitions 850 can comprise one or more databases and/or other types of non-volatile storage facilities to store data in various formats and structures (e.g., data tables 882, computer files 884₁, etc.). The data stored in the storage partitions 850 can be made accessible to the analytics computing platform 830 by a query processor 836 and a result processor 837, which can use various means for accessing and presenting the data, such as a primary key index 883 and/or other means. In one or more embodiments, the analytics computing platform 830 can comprise a performance analysis server 832 and a campaign planning server 834. Operations performed by the performance analysis server 832 and the campaign planning server 834 can vary widely by embodiment. As an example, the performance analysis server 832 can be used to analyze the messages presented to the users (e.g., message data record 870₁ and message data record 870₂) and the associated instances of the interaction event data record 872 to determine various performance metrics associated with a marketing campaign, which metrics can be stored in the campaign metrics data store 856 and/or used to generate various instances of the campaign specification data records 874. Further, for example, the campaign planning server 834 can be used to generate marketing campaign plans and associated marketing spend apportionments, which information can be stored in the campaign plan data store 857 and/or used to generate various instances of the campaign specification data records 874. Certain portions of the interaction event data record 872 might further be used by a data management platform server 838 in the analytics computing platform 830 to determine various user attributes (e.g., behaviors, intent, demographics, device usage, etc.), which attributes can be stored in the subject user data store 858 and/or used to generate various instances of the campaign specification data records 874. One or more instances of an interface application server 835 can execute various software applications that can manage and/or interact with the operations, transactions, data, and/or activities associated with the analytics computing platform 830. For example, a marketing manager might interface with the interface application server 835 to view the performance of a marketing campaign and/or to allocate media spend for another marketing campaign.

In the foregoing specification, the disclosure has been described with reference to specific embodiments thereof. It will, however, be evident that various modifications and changes may be made thereto without departing from the broader spirit and scope of the disclosure. For example, the above-described process flows are described with reference to a particular ordering of process actions. However, the ordering of many of the described process actions may be changed without affecting the scope or operation of the disclosure. The specification and drawings are, accordingly, to be regarded in an illustrative sense rather than in a restrictive sense.

What is claimed is:

1. A computer implemented method comprising:
providing a media planning application for operation on one or more computers;
storing, in a computer, a first set of touchpoint encounters that represent marketing messages exposed to a first set of users in a first marketing campaign;
storing a plurality of historical response vectors that characterize one or more responses of the users exposed to the touchpoint encounters in the first marketing campaign;
processing, using machine-learning techniques in a computer, the touchpoint encounters and the historical response vectors to determine a set of recommended performance values, wherein the recommended performance values reflect importance of the touchpoint encounters, relative to other touchpoint encounters, to the response of the users in the first marketing message;
recommending, in the media planning application, a plurality of recommended touchpoint encounters for a second marketing campaign based at least in part on the recommended performance values;
receiving a second set of historical response vectors corresponding to a plurality of responses of the users exposed to the second marketing campaign with the recommended touchpoint encounters;
processing, in a computer, to generate a historical performance value that measures a first effectiveness of the first set of touchpoint encounters in the first marketing campaign, an updated performance value that measures a second effectiveness of the recommended touchpoint encounters in the second marketing campaign, and a recommended performance value that estimates the performance of the recommended touchpoint encounters; and
displaying, through the media planning application, at least one of the historical performance values, or the updated performance values or the recommended performance values, or any combination thereto, so as to illustrate an effectiveness of the second marketing campaign as recommended by the media planning application.

2. The method of claim 1, wherein the media planning application further to specify at least one media spend apportionment plan.

3. The method of claim 1, further comprising comparing, to identify a plurality of difference values, at least two of, the historical performance values, the updated performance values and the recommended performance values, or any combination thereto.

4. The method of claim 3, wherein at least one of the difference values characterizes at least one of, a measurement error, or a prediction error.

5. The method of claim 3, wherein at least one of the historical performance values, the updated performance values and the recommended performance values, is used to determine at least one of, a response metric, a performance metric, or a return on investment metric.

6. The method of claim 3, further comprising generating at least one of, a maximum response curve, or a maximum performance curve, the generating based at least in part on at least one of, the historical performance values, or the updated performance values or the recommended performance values, or any combination thereto.

7. The method of claim 3, wherein the plurality of difference values are based at least in part on a first one of the recommended performance values, or a first one of the historical performance values or the updated performance values.

8. The method of claim 3, wherein the first one of the recommended performance values was measured at a first time, and the first one of the updated performance values was measured at a second time.

9. The method of claim 8 wherein the second time is a later time than the first time.

10. The method of claim 3, wherein the first one of the historical performance values was measured at a first time, and the first one of the updated performance values was measured at a second time.

11. A computer readable medium, embodied in a non-transitory computer readable medium, the non-transitory computer readable medium having stored thereon a sequence of instructions which, when stored in memory and executed by a processor causes the processor to perform a set of acts, the acts comprising:
providing a media planning application for operation on one or more computers;
storing, in a computer, a first set of touchpoint encounters that represent marketing messages exposed to a first set of users in a first marketing campaign;
storing a plurality of historical response vectors that characterize one or more responses of the users exposed to the touchpoint encounters in the first marketing campaign;
processing, using machine-learning techniques in a computer, the touchpoint encounters and the historical response vectors to determine a set of recommended performance values, wherein the recommended performance values reflect importance of the touchpoint encounters, relative to other touchpoint encounters, to the response of the users in the first marketing message;
recommending, in the media planning application, a plurality of recommended touchpoint encounters for a second marketing campaign based at least in part on the recommended performance values;
receiving a second set of historical response vectors corresponding to a plurality of responses of the users exposed to the second marketing campaign with the recommended touchpoint encounters;
processing, in a computer, to generate a historical performance value that measures a first effectiveness of the first set of touchpoint encounters in the first marketing campaign, an updated performance value that measures a second effectiveness of the recommended touchpoint encounters in the second marketing campaign, and a recommended performance value that estimates the performance of the recommended touchpoint encounters; and
displaying, through the media planning application, at least one of the historical performance values, or the updated performance values or the recommended performance values, or any combination thereto, so as to illustrate an effectiveness of the second marketing campaign as recommended by the media planning application.

12. The computer readable medium of claim 11, wherein the media planning application further to specify at least one media spend apportionment plan.

13. The computer readable medium of claim 11, further comprising instructions which, when stored in memory and executed by a processor causes the processor to perform acts of comparing, to identify a plurality of difference values, at least two of, the historical performance values, the updated performance values and the recommended performance values, or any combination thereto.

14. The computer readable medium of claim 13, wherein at least one of the difference values characterizes at least one of, a measurement error, or a prediction error.

15. The computer readable medium of claim 13, wherein at least one of the historical performance values, the updated performance values and the recommended performance values, is used to determine at least one of, a response metric, a performance metric, or a return on investment metric.

16. The computer readable medium of claim 13, further comprising instructions which, when stored in memory and executed by a processor causes the processor to perform acts of generating at least one of, a maximum response curve, or a maximum performance curve, the generating based at least in part on at least one of, the historical performance values, or the updated performance values or the recommended performance values, or any combination thereto.

17. The computer readable medium of claim 13, wherein the plurality of difference values are based at least in part on a first one of the recommended performance values, or a first one of the historical performance values or the updated performance values.

18. The computer readable medium of claim 13, wherein the first one of the recommended performance values was measured at a first time, and the first one of the updated performance values was measured at a second time.

19. A system comprising:
a network interface port to provide a media planning application for operation on one or more computers;
a storage device to store in a first area, a first set of touchpoint encounters that represent marketing messages exposed to a first set of users in a first marketing campaign, and to store in a second area, a plurality of historical response vectors that characterize one or more responses of the users exposed to the touchpoint encounters in the first marketing campaign; and
a processor or processors that execute instructions to causes the processor or processors to perform a set of acts, the acts comprising,
processing, using machine-learning techniques in a computer, the touchpoint encounters and the historical response vectors to determine a set of recommended performance values, wherein the recommended performance values reflect importance of the touchpoint encounters, relative to other touchpoint encounters, to the response of the users in the first marketing message;
recommending, in the media planning application, a plurality of recommended touchpoint encounters for a second marketing campaign based at least in part on the recommended performance values;
receiving a second set of historical response vectors corresponding to a plurality of responses of the users exposed to the second marketing campaign with the recommended touchpoint encounters;
processing, in a computer, to generate a historical performance value that measures a first effectiveness of the first set of touchpoint encounters in the first marketing campaign, an updated performance value that measures a second effectiveness of the recommended touchpoint encounters in the second marketing campaign, and a recommended performance value that estimates the performance of the recommended touchpoint encounters; and
displaying, through the media planning application, at least one of the historical performance values, or the updated performance values or the recommended performance values, or any combination thereto, so as to illustrate an effectiveness of the second marketing campaign as recommended by the media planning application.

20. The method of claim 1, wherein the media planning application further to specify at least one media spend apportionment plan.
